(19) United States
(12) Patent Application Publication
(10) Pub. No.: US 2026/0339164 A1
(43) Pub. Date: Oct. 29, 2026

(54) Camera Shield for Agricultural Spray Boom

(71) Applicant: Centure Applications LTD, Tel Aviv-Yafo (IL)

(72) Inventors: Ori Sarfaty, Tel Aviv-Yafo (IL); Yuval Oshpizin, Kibbutz Glil-yam (IL)

(21) Appl. No.: 19/457,530

(22) Filed: Jan. 23, 2026

Related U.S. Application Data
(60) Provisional application No. 63/748,521, filed on Jan. 23, 2025.

(51) Int. Cl. G03B 11/04; A01M 7/00; B08B 5/02; B08B 17/02; G03B 17/08

(52) U.S. Cl. CPC G03B 11/045; A01M 7/0064; B08B 5/02; B08B 17/02; G03B 11/043; G03B 17/08

(57) ABSTRACT

A camera shield includes a body defining a hole extending between first and second sides of the body; a lens shield defined on the second side and configured to partially cover a camera lens, the lens shield defining a window aligned with the camera lens and the hole to allow light to reach the camera lens without obstructing its field-of-view; a fluid port on the body is fluidly coupled to a fluid inlet channel defined in the body that fluidly couples the fluid port and the hole; and a fluid outlet channel defined in the body and fluidly coupling the hole to an external environment, the fluid outlet channel spatially aligned with the fluid inlet channel to form a fluid path that extends from the fluid inlet channel to the fluid outlet channel and through the hole so as to deflect particulates from reaching the window and the camera lens.

### CROSS-REFERENCE TO RELATED APPLICATIONS

This application claims priority to U.S. Provisional Application No. 63/748,521, titled “Camera Shield for Agricultural Spray Boom,” filed on Jan. 23, 2025, which is hereby incorporated by reference.

### TECHNICAL FIELD

This application relates generally to cameras for agricultural spray systems.

### BACKGROUND

Agricultural spray systems are widely used in modern farming operations to apply herbicides, pesticides, fertilizers, and other treatments to crops and fields. These systems typically include spray booms that traverse an agricultural field during spraying operations. To improve the precision and effectiveness of spray applications, agricultural spray systems have increasingly incorporated cameras and imaging systems that capture images of the agricultural field during operation. Some agricultural spray systems utilize trained machine-learning models to detect plants, weeds, or other features in the captured images, enabling targeted or selective spraying based on the detected features.

During operation, cameras mounted on spray booms are exposed to harsh environmental conditions. Dust and dirt particles are commonly present in agricultural fields and become airborne as the spray boom travels across the field. Additionally, the spray material applied by the agricultural spray system can drift or splash onto camera components. This debris, including dust, dirt, and spray droplets, can accumulate on camera lenses and obstruct the optical path, degrading image quality and potentially interfering with the detection capabilities of the imaging system.

### SUMMARY

Example embodiments described herein have innovative features, no single one of which is indispensable or solely responsible for their desirable attributes. The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Without limiting the scope of the claims, some of the advantageous features will now be summarized. Other objects, advantages, and novel features of the disclosure will be set forth in the following detailed description of the disclosure when considered in conjunction with the drawings, which are intended to illustrate, not limit, the invention.

An aspect of the invention is directed to a camera shield comprising a body defining a hole extending between a first side of the body and an opposing second side of the body; a lens shield defined on the second side of the body and configured to partially cover a front of a camera lens, the lens shield defining a window configured to be aligned with the camera lens and the hole, the hole and the window configured to allow light to reach the camera lens without obstructing a field-of-view of the lens; a fluid port on the body, the fluid port fluidly coupled to a fluid inlet channel defined in the body, the fluid inlet channel fluidly coupling the fluid port and the hole, the fluid port configured to receive a fluid line; and a fluid outlet channel defined in the body and fluidly coupling the hole to an external environment, the fluid outlet channel spatially aligned with the fluid inlet channel to form a compressed fluid path that extends from the fluid inlet channel to the fluid outlet channel and through the hole so as to deflect particulates from reaching the window and the camera lens.

In one or more embodiments, the hole is defined between first and second sides of the body, and a first axis extends through the first and second sides. In one or more embodiments, the fluid port is on a third side of the body, the fluid inlet channel is defined in the third side of the body, the fluid outlet channel is defined in a fourth side of the body, and a second axis extends through the third and fourth sides, the second axis orthogonal to the first axis. In one or more embodiments, the second axis is parallel to a direction of gravitational pull. In one or more embodiments, the fourth side of the body is closer to the direction of gravitational pull than the third side.

In one or more embodiments, the fluid line comprises a gas line.

In one or more embodiments, the fluid inlet channel extends from the fluid port to an inner surface of the third side, the inner surface of the third side partially defining the hole, and a width of the fluid inlet channel is greater at the inner surface of the third side than at the fluid port so as to distribute a fluid across a width of the hole, the width of the fluid inlet channel and the width of the hole measured with respect to a third axis that is orthogonal to the first and second axes. In one or more embodiments, the fluid outlet channel extends from an inner surface of the fourth side to an outer surface of the fourth side, the inner surface of the fourth side partially defining the hole, and a width of the fluid outlet channel at the inner surface of the fourth side is greater than the width of the fluid inlet channel at the inner surface of the third side, the width of the fluid outlet channel measured with respect to the third axis. In one or more embodiments, the width of the fluid outlet channel at the inner surface of the third side is approximately equal to a width of the window, the width of the window measured with respect to the third axis.

In one or more embodiments, the camera shield further comprises a first air-flow channel defined in a fifth side of the body, the first air-flow channel fluidly coupling the hole to an external environment; and a second air-flow channel defined in a sixth side of the body, the second air-flow channel fluidly coupling the hole to the external environment, wherein the first and second air-flow channels are spatially aligned with each other to form an air-flow path that extends between the first air-flow channel and the second air-flow channel and through the hole, and a third axis passes through the fifth and sixth sides, the third axis orthogonal to the first and second axes.

Another aspect of the invention is directed to a camera shield system comprising the camera shield as described above; a compressed fluid source; and the fluid line, the fluid line fluidly coupling an outlet of the compressed fluid source to the inlet port of the camera shield.

In one or more embodiments, the compressed fluid source comprises a compressed gas source.

Another aspect of the invention is directed to an assembly comprising the camera shield system as described above; and a camera comprising the camera lens, the front of the camera lens disposed in the lens shield.

In one or more embodiments, the assembly further comprises an agricultural spray boom having a frame, wherein the camera and the compressed fluid source are mounted on the frame of the spray boom.

Another aspect of the invention is directed to an a camera protection system comprising a camera having a camera lens; an electromechanical lens cap coupled to a front of the camera lens, the electromechanical lens cap configured to transition between an opened state in which at least a portion of the front of the camera lens is exposed to capture an image and a closed state in which the electromechanical lens cap covers the front of the camera lens to block particulates from reaching the front of the camera lens; and a controller in communication with the electromechanical lens cap, the controller configured to set the electromechanical lens in the open state only for a time period sufficient for the camera to captures an image and to maintain the electromechanical lens in the closed state as a default state when the camera is idle.

In one or more embodiments, the electromechanical lens cap includes an actuator configured to physically move the electromechanical lens cap between the open state and the closed state. In one or more embodiments, the electromechanical lens cap includes a plurality of retractable interleaving segments. In one or more embodiments, the electromechanical lens cap includes a plurality of holes, in the opened state one of the holes is spatially aligned with front of the camera, and in the closed state the holes are not spatially aligned with the front of the camera.

Another aspect of the invention is directed to an assembly comprising the camera protection system as described above; and a spray boom having a frame, the camera mounted on the frame of the spray boom.

In one or more embodiments, the assembly further comprises a compressed fluid source mounted on the spray boom; and an electromechanical valve fluidly coupled to an outlet of the compressed fluid source and in communication with the controller, the electromechanical valve configured to transition from a closed position to an open position to spray a fluid onto the front of the lens when the electromechanical lens is in the open state so as to remove the particulates from the front of the lens.

Another aspect of the invention is directed to a camera protection system comprising a camera having a camera lens, the camera configured to capture images using one or more wavelengths of light; a lens shield covering a front of the camera lens, the lens shield comprising an optically transparent material with respect to the one or more wavelengths of light; and a motor coupled to the lens shield to rotate the lens shield about a central axis that passes through the lens shield and the camera lens so as to remove debris from the lens shield.

Another aspect of the invention is directed to an assembly comprising the camera protection system as described above; and a spray boom having a frame, the camera mounted on the frame of the spray boom.

### BRIEF DESCRIPTION OF THE DRAWINGS

For a fuller understanding of the nature and advantages of the concepts disclosed herein, reference is made to the detailed description of example embodiments and the accompanying drawings.

FIG. 1 is an isometric view of an assembly that includes a camera shield and a camera according to one or more embodiments.

FIG. 2 is a front view of the camera shield illustrated in FIG. 1 according to one or more embodiments.

FIGS. 3A and 3B are isolated side and back views, respectively, of the camera shield illustrated in FIG. 1 according to one or more embodiments.

FIGS. 4A and 4B are side views of the assembly 12 illustrated in FIG. 1 according to one or more embodiments.

FIG. 4C is a side view of the camera mounted on the spray boom without a camera shield to show the protection that the camera shield provides.

FIGS. 5A and 5B are front views of a camera with and without a camera shield, respectively, to further illustrate the protection that the camera shield provides.

FIGS. 6-11 represent a time-series simulation showing how the camera shield prevents most particulates from passing into the camera shield where the particulates could contact the camera lens according to one or more embodiments.

FIGS. 12A-12C show another example of an electromechanical lens cap according to one or more embodiments.

FIGS. 13A-13C show another example of an electromechanical lens cap according to one or more embodiments.

FIG. 14 is a perspective view of a camera shield according to one or more embodiments.

FIG. 15 is a simplified view of a camera shield according to one or more embodiments.

FIG. 16 is a sequence diagram representing electromechanical lens cap operation configurations according to one or more embodiments.

FIG. 17 is a sequence diagram representing a camera lens cleaning process according to one or more embodiments.

FIG. 18 is a sequence diagram representing an air-flow debris protection process for a camera shield according to one or more embodiments.

### DETAILED DESCRIPTION

A camera shield protects a camera lens from debris encountered while the camera is mounted on an agricultural spray boom to capture images during the spraying of an agricultural field. The camera shield can comprise an electromechanically lens cap in one or more embodiments.

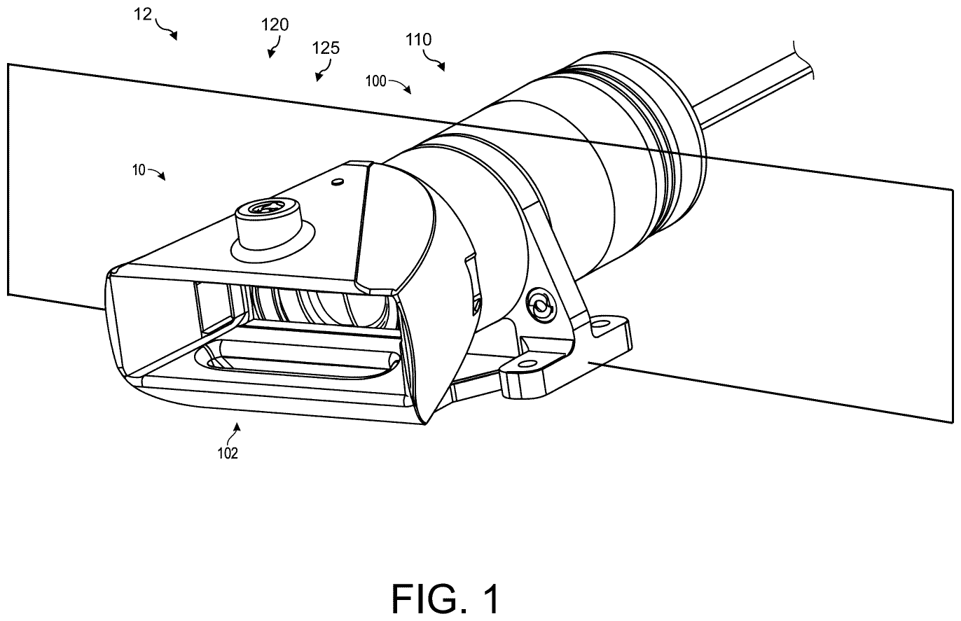

FIG. 1 is an isometric view of an assembly 12 that includes a camera shield 10 and a camera 100 according to one or more embodiments. The camera shield 10 can be mounted on and/or attached to the camera 100, such as a housing 110 of the camera 100, and positioned at a front of the camera 100 to protect a camera lens 102 from particulates (e.g., dust, dirt, spray droplets, and other debris) that may be encountered during agricultural spraying operations.

In some cases, the camera shield 10 may be secured to the camera 100 via a mounting arrangement that attaches to the housing 110 of the camera 100. The housing 110 can be cylindrical or another shape.

The assembly 12 can further includes an agricultural spray boom 120. The camera 100 can be mounted on a frame 125 of the agricultural spray boom 120. For example, the camera 100 can include a mounting bracket to secure the camera 100 to the frame 125 of the spray boom 120.

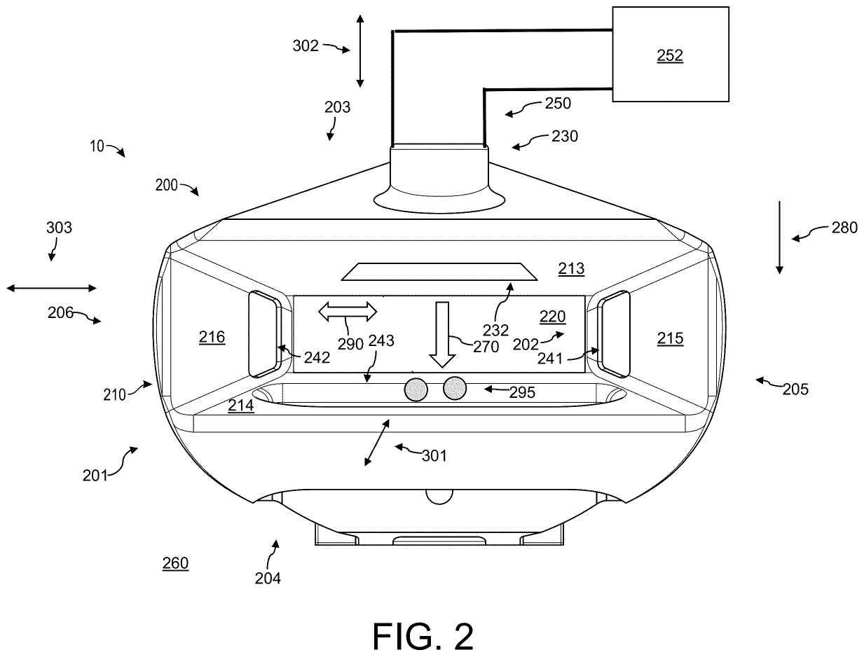

FIG. 2 is a front view of the camera shield 10 according to one or more embodiments. The camera shield 10 has a body 200 that defines a hole 210 through the body 200. The hole 210 extends from a front side 201 of the body 200 to an opposing back side 202 of the body 200. A window 220 is defined in the back side 202 of the body 200. The window 220 is configured to be aligned with the hole 210 and the camera lens 102 (FIG. 1). The window 220 and the hole 210 are configured to allow light to reach the camera lens 102 without obstructing the field-of-view of the camera lens 102.

A fluid port 230 (e.g., fluid inlet port) is defined on the body 200. In one or more embodiments, the fluid port 230 is defined on a top side 203 of the body 200. A fluid inlet channel 232 is defined in the top side 203 of the body 200. The fluid inlet channel 232 fluidly couples the fluid port 230 and the hole 210 to allow a fluid, such as a gas, to flow from the fluid port 230 to the hole 210. The fluid port 230 is configured to be mechanically and fluidly coupled to a fluid line 250 to receive a fluid such as a gas (e.g., air or another gas) from a compressed/pressurized fluid source 252 that can be mounted on the agricultural spray boom 120 (FIG. 1).

A fluid outlet channel 243 is defined in the body 200. In one or more embodiments, the fluid outlet channel 243 is defined on a bottom side 204 of the body 200. The bottom side 204 can be positioned closer to a direction of gravitational pull 280 than the top side 203. The fluid outlet channel 243 fluidly couples the hole 210 and an external environment 260 of the camera shield 10. The fluid outlet channel 243 can be spatially aligned with the fluid inlet channel 232 to form a fluid path 270 from the fluid inlet channel 232 to the fluid outlet channel 243 and through the hole 210.

As the assembly 12 (FIG. 1) moves across the agricultural field, for example during agricultural spraying, fluid flowing along the fluid path 270 directs and/or deflects particulates 295 in the air (e.g., dust, dirt, and/or spray droplets) towards the fluid outlet channel 243 and away from the window 220 (and the camera lens 102) to reduce the accumulation of particulates 295 on the camera lens 102.

In one or more embodiments, optional air-flow channels and/or air-flow holes can be defined in the body 200. For example, an optional first air-flow channel 241 can be defined in a first lateral side 205 of the body 200 and an optional second air-flow channel 242 can be defined in a second lateral side 206 of the body 200. Each of the optional first and second air-flow channels 241, 242 fluidly couple the hole 210 to the external environment 260. The optional first and second air-flow channels 241, 242 can be spatially aligned to form an air-flow path 290 that extends between the optional first and second air-flow channels 241, 242 and through the hole 210. Air flow produced as the agricultural spray system, including the camera shield 10 and the camera 100 (FIG. 1), travels across the agricultural field and/or wind from the external environment 260 can pass through the optional first and second air-flow channels 241, 242 and/or through the fluid outlet channel 243 to decrease the wind resistance of the camera shield 10.

In one or more embodiments, a first axis 301 can pass through the front and back sides 201, 202 of the body 200. Additionally or alternatively, a second axis 302 can pass through the top and bottom sides 203, 204 of the body 200. Additionally or alternatively, a third axis 303 can pass through the first and second lateral sides 205, 206 of the body 200. The first, second, and third axes 301-303 can be mutually orthogonal.

In one or more embodiments, the fluid outlet channel 243 has a width, as measured with respect to the third axis 303, that is larger than the width of the fluid inlet channel 232. In one or more embodiments, the fluid inlet channel 232 has a width, at an inner surface 213 of the top side 203 of the body 200, than a width of the fluid port 230 at an inner surface 214 of the bottom side 204, as measured with respect to the third axis 303. The larger width of the fluid inlet channel 232 at the inner surface 213 can allow the fluid to be distributed across the width of the hole 210, as measured with respect to the third axis 303. In one or more embodiments, the width of the fluid outlet channel 243 at the inner surface 214 of the bottom side 204 can be equal or about equal to (e.g. within about 10% of) the width of the window 220, as measured with respect to the third axis 303.

The hole 210 is defined in part by the inner surfaces 213, 214 of the top and bottom sides 203, 204, respectively. The hole 210 is further defined by inner surfaces 215, 216 of the first and second lateral sides 205, 206, respectively.

It is noted that the relative terminology the front side 201, the back side 202, the top side 203, the bottom side 204, the first lateral side 205, and the second lateral side 206 can refer to the respective sides of the body 200 when the camera shield 10 is oriented such that the bottom side 204 faces downward (toward the direction of gravitational pull 280). In other orientations, any of the sides of the body 200 can face downward and can be referred to as a bottom side. In one or more embodiments, the front side 201, the back side 202, the top side 203, the bottom side 204, the first lateral side 205, and the second lateral side 206 can be referred to as a first side 201, a second side 202, a third side 203, a fourth side 204, a fifth side 205, and a sixth side 206, respectively.

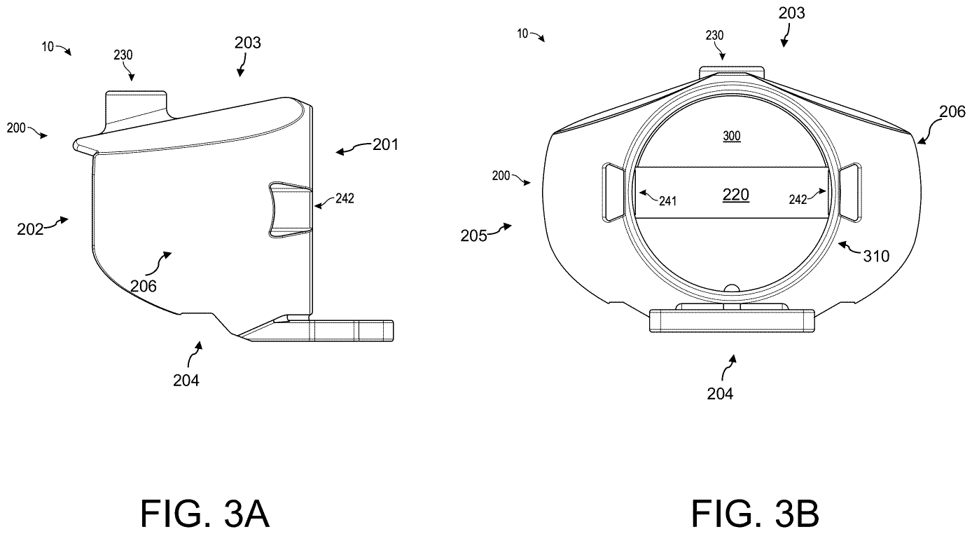

FIGS. 3A and 3B are isolated side and back views of the camera shield 10, respectively. In FIG. 3A, the side view shows the camera shield 10 with the body 200 having a generally curved profile. The fluid port 230 may be positioned at the top of the body 200 and may be configured to receive compressed (e.g., pressurized) air. The optional second lateral air-flow channel 242 may be visible on a side of the body 200, providing a passage for air to flow through the camera shield 10.

In FIG. 3B the back view illustrates a lens shield 300 defined on the back side 202 of the body 200. The window 220 is defined in the lens shield 300 and configured to be aligned with the camera lens 102 (FIG. 2). The lens shield 300 is configured to cover the camera 100, such as the housing 110 (FIG. 1), while the window 220 allows light to pass through to the camera lens 102 (e.g., within the field-of-view of the camera lens 102) such that the front of the camera 100 (e.g., the front of the housing 110) is partially covered. The lens shield 300 can be circular and/or another shape that can correspond and/or be complementary to the shape of the camera 100 (FIG. 1) such as the camera lens 102 or housing 110 (FIG. 1). A flange 310 can be disposed about a perimeter of the lens shield 300 and can mechanically engage the camera 100 (e.g., the housing 110 and/or the camera lens 102).

As further shown in FIG. 3B, the optional first lateral air-flow channel 241 and the optional second lateral air-flow channel 242 may be positioned on opposite lateral sides 205, 206 of the body 200. The optional first lateral air-flow channel 241 and the optional second lateral air-flow channel 242 may flank the window 220 on opposite lateral sides of the camera shield 10. The fluid port 230 may be visible at the top of the body 200 in the back view. The arrangement of the fluid port 230, the window 220, and the optional first lateral air-flow channel 241 and the optional second lateral air-flow channel 242 may facilitate the direction of debris away from the window 220 while allowing air to pass through the camera shield 10.

In some cases, air flow passing through the first lateral air-flow channel 241 and the second lateral air-flow channel 242 may decrease wind resistance of the camera shield 10. Air flow produced as an agricultural spray system, including the camera shield 10 and the camera 100, travels across an agricultural field may pass through the first lateral air-flow channel 241, the second lateral air-flow channel 242, and the bottom air-flow channel 243. The passage of air through the first lateral air-flow channel 241 and the second lateral air-flow channel 242 may reduce aerodynamic drag on the camera shield 10 during operation of the agricultural spray system.

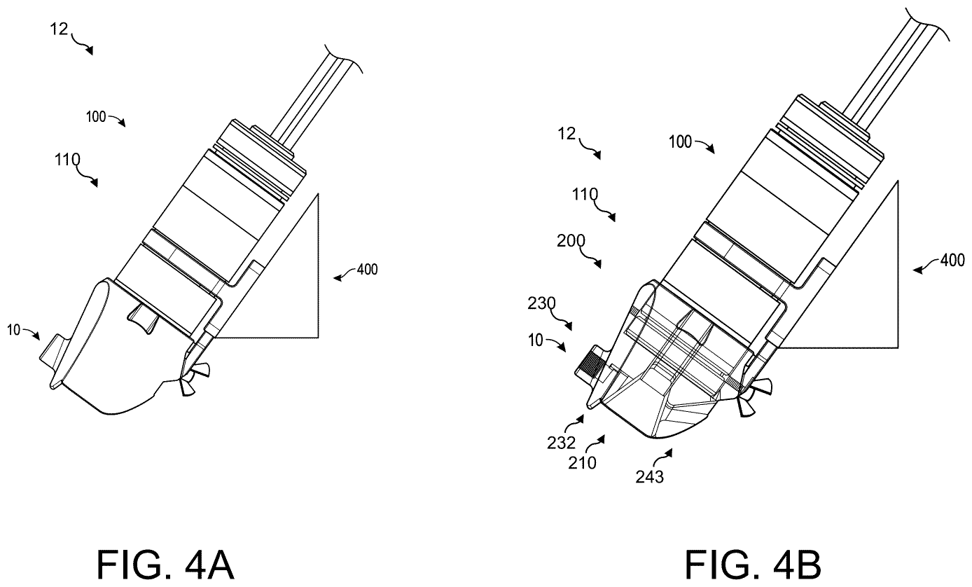

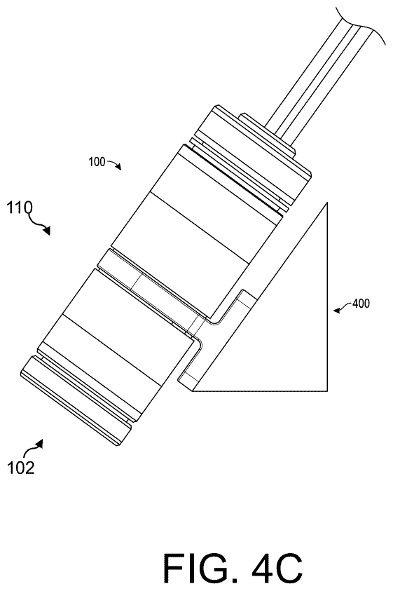

FIGS. 4A and 4B are side views of the assembly 12 with the camera shield 10 mounted on the camera 100 according to one or more embodiments. The camera shield 10 is shown as partially transparent in FIG. 4B. The camera 100 is mounted on an agricultural spray boom 400 at an angle. In one or more embodiments, the angled mounting configuration of the camera 100 on the agricultural spray boom 400 may allow for image capture of an agricultural field below while the camera shield 10 provides protection against environmental contaminants such as particulates.

As further shown in FIGS. 4A and 4B, the camera shield 10 may be attached to a front portion of the camera 100 (e.g., to the housing 110) to protect the camera lens 102 from dust, dirt, spray, and other debris encountered during use. The camera shield 10 may be configured to be mounted on the camera 100, and camera 100 can be mounted on the agricultural spray boom 400 at an angle. In some cases, the angled mounting of the camera 100 on the agricultural spray boom 400 may position the camera lens 102 to capture images of crops or other features in the agricultural field as the spray boom 400 travels across the field. The partially transparent view of the camera shield 10 in FIG. 4B may illustrate how the body 200 of the camera shield 10 surrounds and protects the camera lens 102, and can further illustrate fluid connection of the hole 210, the fluid inlet channel 232, the fluid outlet channel 243, and the fluid port 230.

FIG. 4C is a side view of the camera 100 mounted on the spray boom 400 without a camera shield 10 to show the protection that the camera shield 10 provides. In some cases, the absence of a camera shield may illustrate the exposure of the camera lens 102 to debris that may be encountered during agricultural spraying operations. The debris may include dust, dirt, and spray that may contact the camera lens 102 when the camera 100 is operated without protective shielding. The configuration shown in FIG. 4C demonstrates the vulnerability of the camera lens 102 when the camera 100 is mounted on the spray boom 400 without a camera shield to deflect or block debris from reaching the camera lens 102.

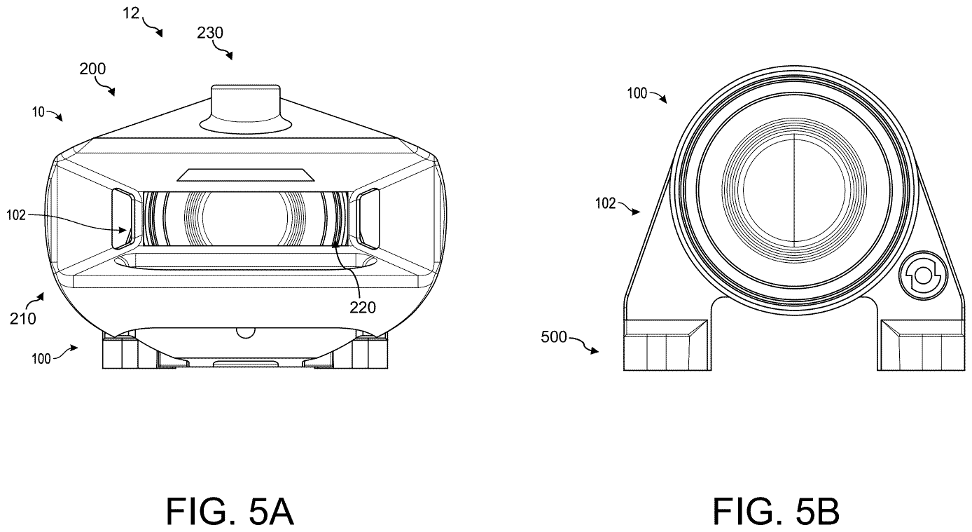

FIGS. 5A and 5B are front views of a camera 100 with and without a camera shield 10, respectively, to further illustrate the protection that the camera shield 10 provides. FIG. 5A is a front view of the assembly 12 according to one or more embodiments.

In FIG. 5A, the camera shield 10 may be mounted on the camera 100, with the camera lens 102 visible through the hole 210 and window 220 of the camera shield 10. The camera shield 10 is configured to surround and protect the camera lens 102 from particulates (e.g., dust, dirt, spray droplets, and/or other debris) that may be encountered during agricultural spraying operations, such that the camera lens 102 in a protected state. The optional first and second lateral air-flow channels 241, 242 are shown. The optional first and second lateral air-flow channels 241, 242 allow air to pass through and reduce wind resistance while the agricultural spray system including the assembly 12 travels across the field. The camera lens 102 may be positioned within the protective enclosure formed by the camera shield 10, with the hole 210 and window 220 providing an unobstructed optical path for light to reach the camera lens 102 within the field-of-view of the camera lens 102.

In FIG. 5B, the camera 100 is shown without a camera shield which can leave the camera lens 102 in an unprotected state. The camera 100 may include a mounting structure 500 at a base of the camera 100 for attachment to an agricultural spray boom 400 (FIGS. 4A-4C). The unprotected state of the camera lens 102 shown in FIG. 5B may expose the camera lens 102 to particulates (e.g., dust, dirt, spray droplets, and/or other debris) that may accumulate on the camera lens 102 during agricultural spraying operations, which can obstruct and/or degrade the images captured by the camera 100. In contrast, the protective coverage provided by the camera shield 10 (FIG. 5A) may reduce the accumulation of these particulates during agricultural spraying operations, which may improve and/or maintain image quality captured by the camera 100 during agricultural spraying operations compared to when the camera 100 is in an unprotected state.

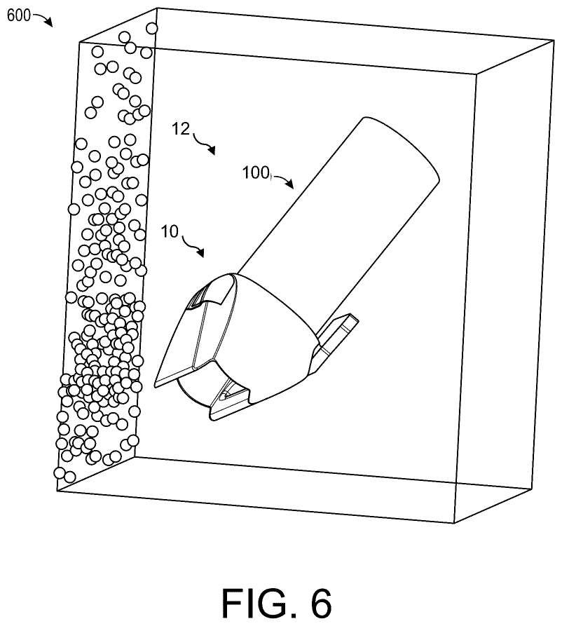

FIGS. 6-11 represent a time-series simulation showing how the camera shield 10 prevents most particulates 600 from passing into the camera shield 10 where the particulates 600 could contact the camera lens 102 (e.g., FIG. 1) according to one or more embodiments.

FIG. 6 shows an initial position of the particulates 600 relative to the assembly 12. The particulates 600 are initially located upstream of the assembly 12. The assembly 12 is shown at angle corresponding to the mounting angle on an agricultural spray boom 400 (FIGS. 4A-4C). The simulation may be performed using computational fluid dynamics software. A rectangle can represent a simulation volume. Coordinate axes can represent the X, Y, and Z directions of the simulation environment.

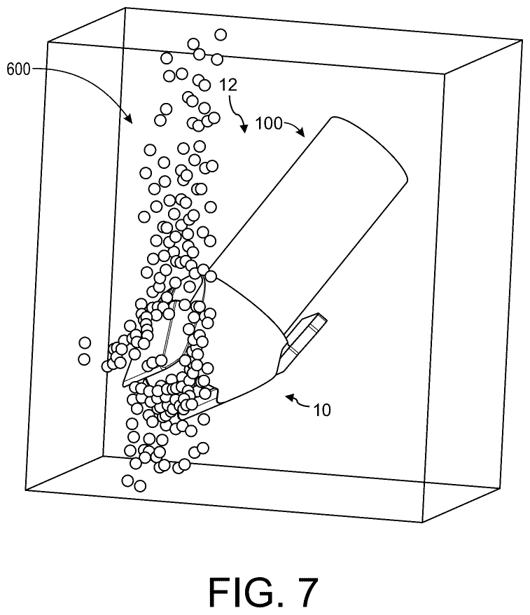

FIG. 7 shows the position of the particulates 600 relative to the assembly 12 at a first point in time after the initial position shown in FIG. 6. As the particulates 600 interact with the camera shield 10 and move downward, some particles may exhibit higher velocities. As further shown in FIG. 7, the simulation may demonstrate how the camera shield 10 redirects the particulates 600 away from the camera lens area. In some cases, the particulates 600 may be deflected around and below the camera shield 10 rather than passing through to contact the camera lens. The particulates 600 can move along trajectories that curve around the exterior surfaces of the camera shield 10, with the particulates 600 being directed away from the hole 210 and the window 220 (FIG. 2) where the camera lens 102 (e.g., FIG. 1) is positioned.

In one or more embodiments, the deflection of the particulates 600 around the camera shield 10 may be caused, at least in part, by an aerodynamic profile of the camera shield 10.

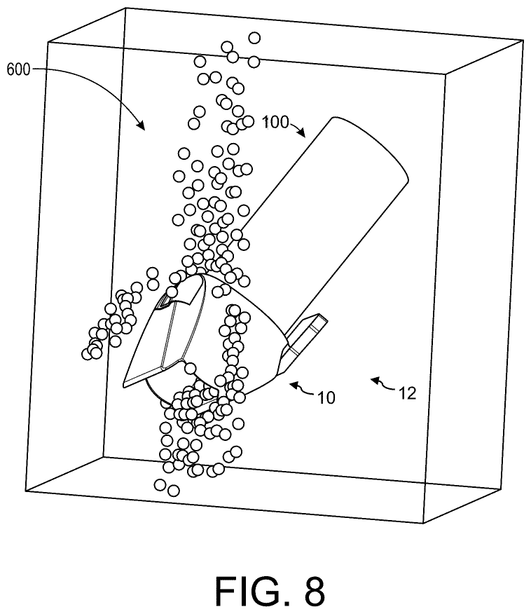

FIG. 8 shows the position of the particulates 600 relative to the assembly 12 at a second point in time after the first point in time shown in FIG. 7. The velocities of the particulates 600 can vary as the particulates 600 move around the camera shield 10. In some cases, the particulates 600 approaching the camera shield 10 may exhibit different (lower) velocities compared to the particulates 600 that have already passed around the camera shield 10. The velocity variations may result from aerodynamic forces acting on the particulates 600 as the particulates 600 encounter the exterior surfaces of the camera shield 10. The particulates 600 have trajectories that curve around the camera shield 10 rather than passing through to contact the camera lens.

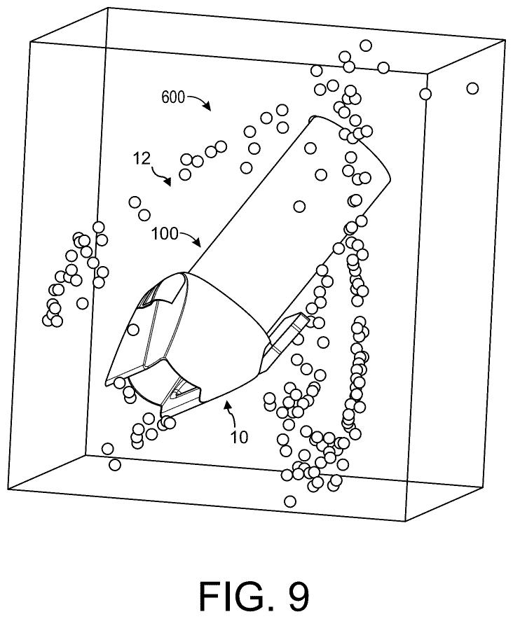

FIG. 9 shows the position of the particulates 600 relative to the assembly 12 at a third point in time after the second point in time shown in FIG. 8. The velocities of the particulates 600 can vary as the particulates 600 move around the camera shield 10. The particulates 600 have trajectories that curve around the camera shield 10 rather than passing through to contact the camera lens.

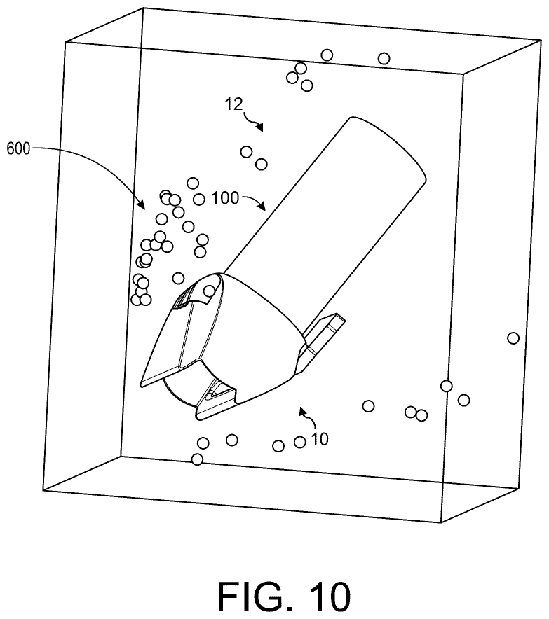

FIG. 10 shows the position of the particulates 600 relative to the assembly 12 at a fourth point in time after the third point in time shown in FIG. 9. The simulation shows that majority of the particulates 600 may be positioned outside a direct path to the camera lens area. The distribution of the particulates 600 around the camera shield 10 may illustrate the protective function of the camera shield 10 in preventing debris from reaching the camera lens during operation.

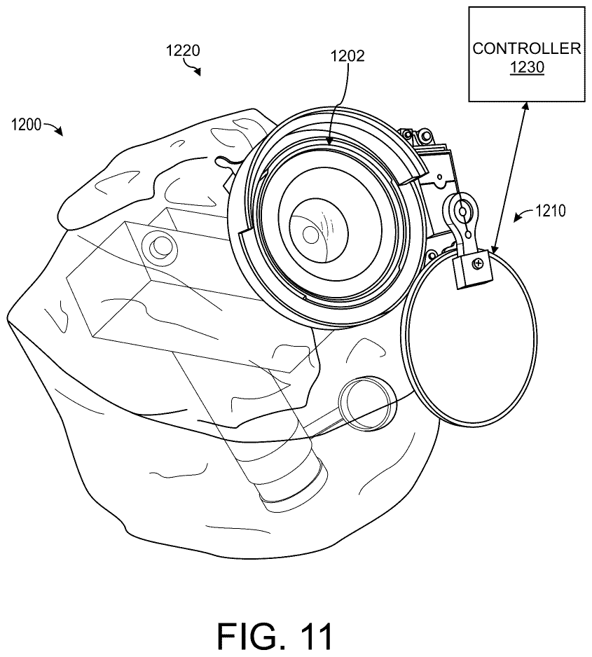

FIG. 11 is a front view of a camera 1220 that includes a camera shield 1200 according to one or more embodiments. The camera shield 1200 comprises an electromechanical lens cap 1210 that is configured to cover the camera lens 1202 while the camera 1220 is not capturing an image and to open and expose the camera lens 102 while the camera 1220 is capturing an image. The electromechanical lens cap 1210 is in a closed state when the electromechanical lens cap 1210 covers the camera lens 1202 and in an opened state when the electromechanical lens cap 1210 does not cover the camera lens 1202. In one or more embodiments, the electromechanical lens cap 1210 can include a circular disc-shaped body that can be positioned in front of the camera lens 1202 to physically block particulates from reaching and/or accumulating on the camera lens 1202.

The state of the electromechanical lens cap 1210 can be controlled by a processor-based controller 1230 in communication with the electromechanical lens cap 1210 or in communication with a motor or actuator that is mechanically coupled to the electromechanical lens cap 1210. The controller 1230 can send control signal(s) that can cause the electromechanical lens cap 1210 to transition between the open and closed states which can be coordinated with control signals (e.g., from the controller 1230 or another controller) that cause the camera 1220 to capture one or more images. The camera 1220 can be the same as the camera 100 (e.g., FIG. 1).

In one or more embodiments, the electromechanical lens cap 1210 may be electromechanically coupled to an actuator that can move the automatic mechanical shutter 1210 between the opened position and the closed position. In other cases, the electromechanical lens cap 1210 may be mechanically coupled to a motor or another device that can translate the electromechanical lens cap 1210 between the opened position (or opened state) and the closed position (or closed state).

In one or more embodiments, the controller 1230 can be configured to maintain the electromechanical lens cap 1210 in the closed state as a default state of the electromechanical lens cap 1210. The controller 1230 can be configured to transition the electromechanical lens cap 1210 to the opened state only when the camera 1220 captures image(s) and can return the electromechanical lens cap 1210 to the closed state when the camera 1220 does not capture image(s). The controller 1230 can be disposed in a housing of the camera 1220 in one or more embodiments.

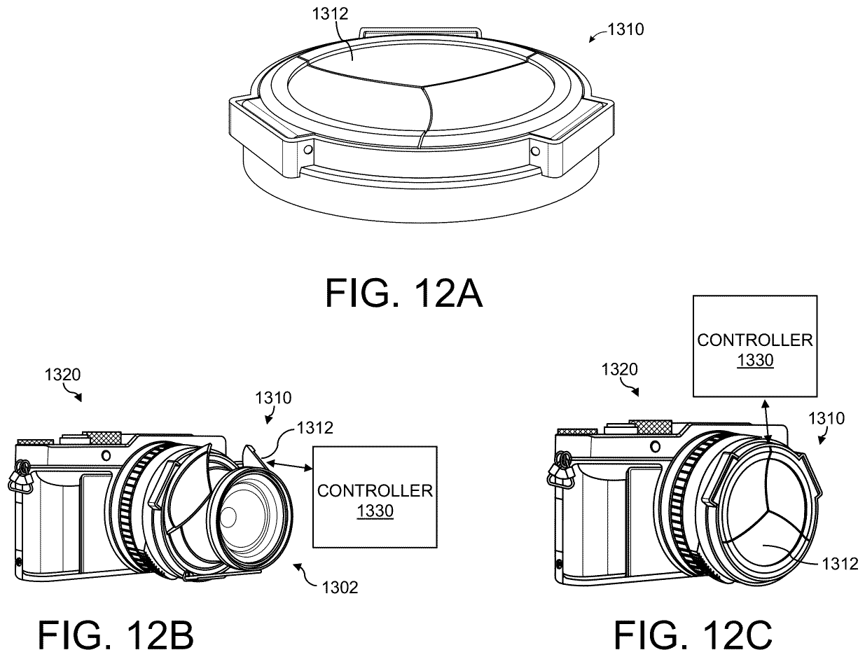

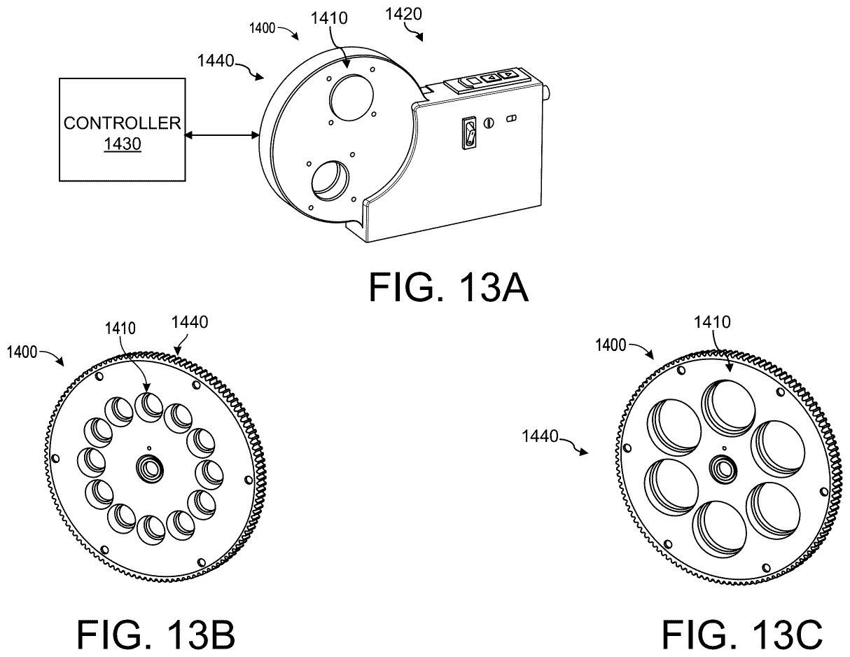

FIGS. 12A, 12B, and 12C show another example of electromechanical lens cap 1310 according to one or more embodiments. The electromechanical lens cap 1310 is configured to cover the camera lens 1302 while the camera 1320 is not capturing an image and to open and expose the camera lens 1302 while the camera 1320 is capturing an image. The electromechanical lens cap 1310 is in a closed state when the electromechanical lens cap 1310 covers the camera lens 1302 and in an opened state when the electromechanical lens cap 1310 does not cover the camera lens 1302.

In one or more embodiments, the electromechanical lens cap 1310 can include a circular disc-shaped body that can be positioned in front of the camera lens 1302 to physically block particulates from reaching and/or accumulating on the camera lens 1302. The electromechanical lens cap 1310 includes a plurality of interleaving segments 1312 that can be retracted in the opened state and in physical contact in the closed state.

The electromechanical lens cap 1310 may be mechanically or electromechanically coupled to a motor, an actuator, or another device that can translate the electromechanical lens cap 1310 between the opened position (opened state) and the closed position (closed state). In one or more embodiments, the electromechanical lens cap 1310 may be coupled to a linear actuator or a rotary actuator configured to move the electromechanical lens cap 1310 between the opened position and the closed position. The electromechanical lens cap 1310 may form part of a camera protection system for an agricultural spray boom, wherein the camera protection system comprises a camera having a camera lens and the mechanical shutter 1310 configured to transition between the opened position in which the camera lens is exposed to capture an image and the closed position in which the mechanical shutter 1310 covers the camera lens to block debris from reaching the camera lens.

The state of the electromechanical lens cap 1310 can be controlled by a processor-based controller 1330 in communication with the electromechanical lens cap 1310 or in communication with a motor or actuator that is mechanically coupled to the electromechanical lens cap 1310. The controller 1330 can send control signal(s) that can cause the electromechanical lens cap 1310 to transition between the open and closed states which can be coordinated with control signals (e.g., from the controller 1330 or another controller) that cause the camera 1320 to capture one or more images. The camera 1320 can be the same as the camera 100 (e.g., FIG. 1).

In one or more embodiments, the controller 1330 can be configured to maintain the electromechanical lens cap 1310 in the closed state as a default state of the electromechanical lens cap 1310. The controller 1330 can be configured to transition the electromechanical lens cap 1310 to the opened state only when the camera 1320 captures image(s) and can return the electromechanical lens cap 1310 to the closed state when the camera 1320 does not capture image(s). The controller 1330 can be disposed in a housing of the camera 1320 in one or more embodiments.

In one or more embodiments, the camera 1220, 1320 (FIGS. 11, 12A-12C) may be configured to capture images at a rate of 100 Hz or less with an exposure time of about 225 microseconds. At an image capture rate of 100 Hz with an exposure time of about 225 microseconds, the camera lens may be exposed for approximately 22.5 milliseconds for each second. In some cases, the exposure time of approximately 22.5 milliseconds per second may represent approximately 2% of the total operating time. The mechanical shutter 1310 may be configured to be in the closed position for at least about 98% of the operating time when the camera captures images at a rate of 100 Hz or less with an exposure time of about 225 microseconds.

In one or more embodiments, the camera 1220, 1320 may be configured to capture images at a rate of 45 to 50 Hz. When the image capture rate is lowered to 45 to 50 Hz, the electromechanical lens cap 1210, 1310 (FIGS. 11, 12A-12C) may be configured to be in the closed position for at least 99% of the operating time. In some cases, the reduced image capture rate may allow the electromechanical lens cap 1210, 1310 to remain in the closed position for a greater percentage of the operating time, thereby providing increased protection of the camera lens from debris during agricultural spraying operations. The electromechanical lens cap 1210, 1310 may prevent debris from reaching the camera lens 1202, 1302, respectively, during the periods when the electromechanical lens cap 1210, 1310 is in the closed position, while allowing the respective camera 1220, 1320 to capture images during the brief periods when the electromechanical lens cap 1210, 1310 transitions to the opened position.

In some embodiments, the camera lens 1202, 1302 can be actively cleaned while the electromechanical lens cap 1210, 1310 is opened. For example, a gas and/or a liquid can be sprayed on and/or across the camera lens to remove debris from the camera lens. In some embodiments, the electromechanical lens cap 1210, 1310 can be used in combination with the camera shield 10.

FIGS. 13A, 13B, and 13C show an electromechanical lens cap 1400 for a camera 1420 according to one or more embodiments. The electromechanical lens cap 1400 has one or more holes 1410 and a housing 1440. In one or more embodiments, the electromechanical lens cap 1400 can comprise a circular disc component and can have a gear-toothed outer edge. The one or more holes 1410 may extend through the electromechanical lens cap 1400, and the housing 1440 may comprise solid portions of the electromechanical lens cap 1400 between the one or more holes 1410.

The electromechanical lens cap 1400 is in an opened state (e.g., a first rotational state) when one of the holes 1410 is aligned with the lens of the camera 1420. The electromechanical lens cap 1400 is in a closed state (e.g., a second rotational state) when none of the holes 1410 is/are aligned with the lens of the camera 1420 such that the solid housing 1440 physically blocks the lens of the camera 1420. The electromechanical lens cap 1400 can rotate between the first rotational state and the second rotational state to alternately expose and protect the camera lens during operation.

The state of the electromechanical lens cap 1400 can be controlled by a processor-based controller 1430 in communication with the electromechanical lens cap 1400 or in communication with a motor or actuator that is mechanically coupled to the electromechanical lens cap 1400. The controller 1430 can send control signal(s) that can cause the electromechanical lens cap 1400 to transition between the open and closed states which can be coordinated with control signals (e.g., from the controller 1430 or another controller) that cause the camera 1420 to capture one or more images. The camera 1420 can be the same as the camera 100 (e.g., FIG. 1).

In one or more embodiments, the controller 1430 can be configured to maintain the electromechanical lens cap 1400 in the closed state as a default state of the electromechanical lens cap 1400. The controller 1430 can be configured to transition the electromechanical lens cap 1400 to the opened state only when the camera 1420 captures image(s) and can return the electromechanical lens cap 1400 to the closed state when the camera 1420 does not capture image(s). The controller 1430 can be disposed in a housing of the camera 1420 in one or more embodiments.

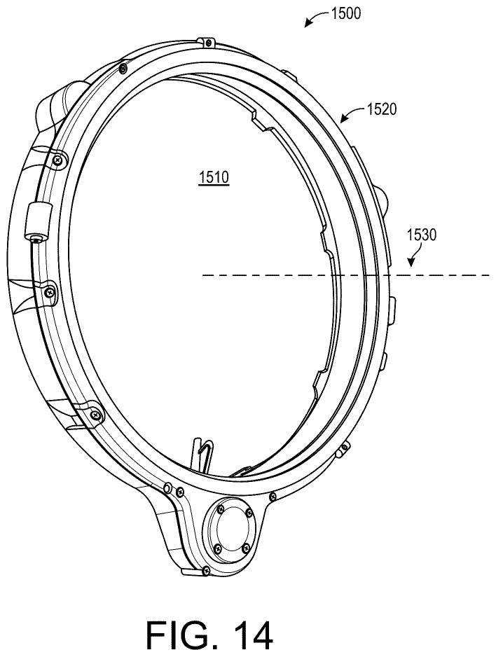

FIG. 14 is a perspective view of a camera shield 1500 according to one or more embodiments. The camera shield 1500 comprises a clear window 1510 mounted to a housing 1520. The camera shield 1500 is configured to be placed directly in front of a camera lens to obstruct debris from reaching the camera lens. The housing 1520 may surround the clear window 1510 and may provide structural support for the camera shield 1500.

The camera shield 1500 can be configured to rotate and/or spin about a central axis 1530 that can extend through the center of the camera shield 1500. When debris (e.g., particulates) contacts the clear window 1510, the centrifugal force of the rotating camera shield 1500 can causes the debris to move outward and off of the clear window 1510, providing the camera lens a clear field of view. The camera shield 1500 can include or can be mechanically or electromechanically coupled to a rotational means such as a motor, an actuator (e.g., a rotary actuator or another actuator), or another device to rotate/spin the camera shield 1500.

The clear window 1510 comprises an optically transparent material that is optically transparent to the wavelength(s) of light captured by a camera 100 (FIG. 1) during agricultural spraying operations. The camera shield 1500 can comprise a clearview screen, a clear sight, a spin window, or a rotating windshield wiper in some embodiments. The camera shield 1500 may protect the camera lens from debris while maintaining optical clarity for image capture by the camera.

In some embodiments, the camera shield 10, the electromechanical lens cap 1210, 1310, the electromechanical lens cap 1400, and/or the camera shield 1500 can be combined.

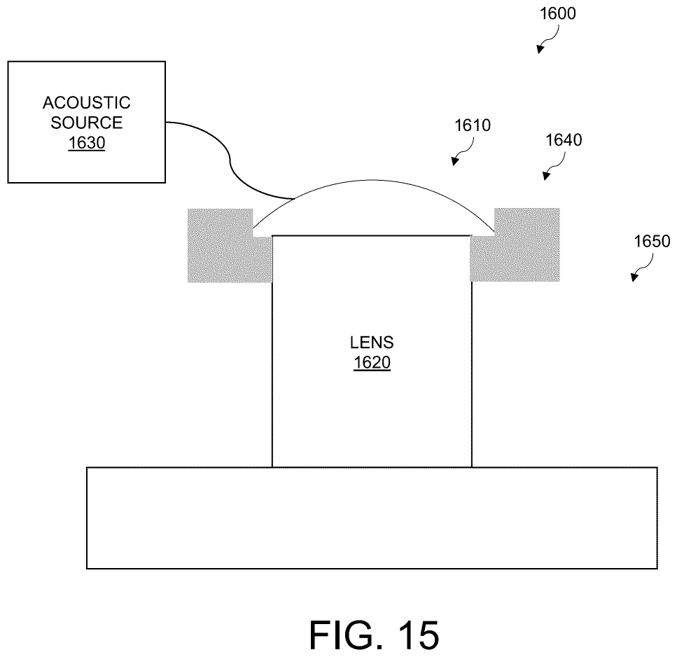

FIG. 15 is a simplified view of a camera shield 1600 according to one or more embodiments. The camera shield 1600 includes a lens cover 1610 that is disposed over a camera lens 1620 to protect the camera lens 1620 of a camera 1650 from debris. An acoustic source 1630 is acoustically coupled to the lens cover 1610. The acoustic source 1630 produces acoustic energy that causes the lens cover 1610 to vibrate at amplitudes sufficient to remove any debris accumulated thereon. The acoustic source 1630 can produce the acoustic energy continuously, periodically, or at other times or intervals. The acoustic energy can include ultrasonic energy and/or other acoustic frequencies.

The lens cover 1610 comprises an optically transparent material that is optically transparent to the wavelength(s) of light captured by the camera 1650 during agricultural spraying operations.

A housing 1640 can be disposed on the lens cover 1610 to secure the lens cover 1610 to the camera lens 1620. Additionally or alternatively, the lens cover 1610 can be secured to the camera lens 1620 using an adhesive.

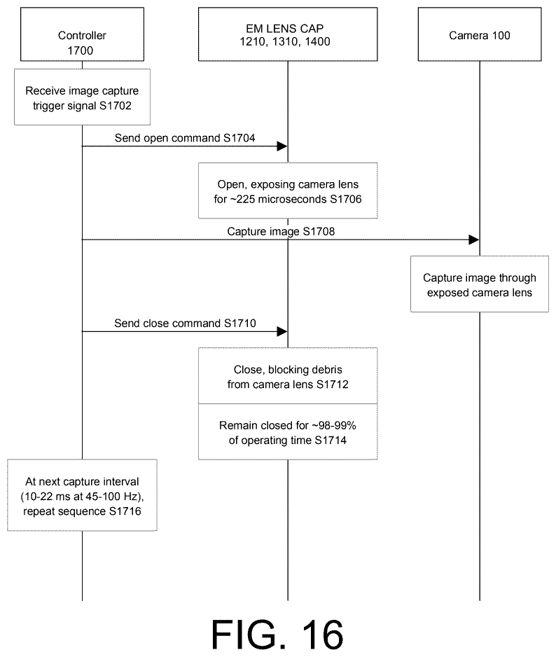

FIG. 16 is a sequence diagram representing electromechanical lens cap operation configurations according to one or more embodiments. The sequence diagram may include a controller 1700, electromechanical lens cap 1210, 1310, 1400, a camera 100, and a trigger source. The sequence diagram may depict three distinct operational configurations for the electromechanical lens cap 1210, 1310, 1400 to protect the camera lens from debris during agricultural spraying operations. The camera 100 can be the same as any of the cameras described herein.

With continued reference to FIG. 16, a first configuration shown in the sequence diagram may be a normally “simple” open configuration. In the normally “simple” open configuration, the electromechanical lens cap 1210, 1310, 1400 may remain in a normally open position during operation in a step S1702. The trigger source may send a close trigger signal to the controller 1700 in a step S1704. The controller 1700 may then command the electromechanical lens cap 1210, 1310, 1400 to close in a step S1706. The electromechanical lens cap 1210, 1310, 1400 may remain closed for X milliseconds in a step S1708, where X may be determined by sprayer speed and boom height parameters. In some cases, the value of X may vary based on operating conditions of the agricultural spray system. The controller 1700 may command the electromechanical lens cap 1210, 1310, 1400 to return to the open position in a step S1710.

As further shown in FIG. 16, a second configuration may be a normally “smart” open configuration. In the normally “smart” open configuration, the electromechanical lens cap 1210, 1310, 1400 may remain in a normally open position during operation in a step S1712. When the trigger source 1710 sends a close trigger signal to the controller 1700 in a step S1714, the controller 1700 may calculate a time delta between two most recent triggers in a step S1716. In some cases, the normally “smart” open configuration may assume that speed changes slowly during operation. The controller 1700 may then command the electromechanical lens cap 1210, 1310, 1400 to close for the calculated delta duration in a step S1718. The electromechanical lens cap 1210, 1310, 1400 may return to the open position after the delta duration expires in a step S1720.

With continued reference to FIG. 16, a third configuration may be a normally closed configuration. In the normally closed configuration, the electromechanical lens cap 1210, 1310, 1400 may remain in a normally closed position during operation in a step S1722. The camera 100 may generate a camera exposure trigger or lighting trigger signal in a step S1724. The trigger source 1710 may send an open trigger signal to the controller 1700 synchronized with the exposure trigger in a step S1726. The controller 1700 may command the electromechanical lens cap 1210, 1310, 1400 to open in a step S1728. The camera 100 may capture an image while the electromechanical lens cap 1210, 1310, 1400 is open in a step S1730. After image capture, the controller 1700 may command the electromechanical lens cap 1210, 1310, 1400 to return to the closed position in a step S1732.

In some cases, the three operational configurations depicted in FIG. 16 may allow the camera lens to be protected for a majority of operating time. Since images may be captured at rates of 100 Hz or less with exposure times of approximately 225 microseconds, the camera lens may be closed for approximately 98% to 99% of the time. In some cases, the protection provided by the electromechanical lens cap 1210, 1310, 1400 during the closed periods may reduce debris accumulation on the camera lens during agricultural spraying operations.

With continued reference to FIG. 16, the process may begin with the controller receiving an image capture trigger signal in the step S1702. The image capture trigger signal may indicate that the camera 100 should capture an image. In some cases, the image capture trigger signal may be generated at predetermined intervals corresponding to an image capture rate of the camera 100. In the step S1704, the controller 1700 may send an open command to the electromechanical lens cap 1210, 1310, 1400 to transition from the closed position to the opened position.

As further shown in FIG. 16, in the step S1706, the electromechanical lens cap 1210, 1310, 1400 may open, exposing the camera lens for approximately 225 microseconds exposure time. In some cases, the exposure time may correspond to a duration during which the camera lens is exposed to capture light for image formation. In the step S1708, the camera 100 may capture an image through the exposed camera lens during the exposure time window. The image capture may occur while the electromechanical lens cap 1210, 1310, 1400 is in the opened position.

With continued reference to FIG. 16, following image capture, in the step S1710, the controller 1700 may send a close command to the electromechanical lens cap 1210, 1310, 1400 to transition from the opened position to the closed position. In the step S1712, the electromechanical lens cap 1210, 1310, 1400 may close, blocking debris from reaching the camera lens during a non-capture period. In some cases, the closed position of the electromechanical lens cap 1210, 1310, 1400 may protect the camera lens from dust, dirt, spray, and other debris that may be encountered during agricultural spraying operations.

As further shown in FIG. 16, in the step S1714, the electromechanical lens cap 1210, 1310, 1400 may remain closed for approximately 98-99% of the operating time between image captures. In some cases, the electromechanical lens cap 1210, 1310, 1400 may provide protection against debris accumulation on the camera lens during the periods when the camera 100 is not actively capturing images. In the step S1716, at a next capture interval of approximately 10-22 milliseconds corresponding to capture rates of 45-100 Hz, the controller 1700 may repeat the sequence starting at the step S1702.

In some cases, the cyclical operation depicted in FIG. 16 may provide continuous protection of the camera lens while enabling periodic image capture for agricultural field monitoring applications. The electromechanical lens cap 1210, 1310, 1400 may transition between the opened position and the closed position in coordination with image capture events, with the electromechanical lens cap 1210, 1310, 1400 remaining in the closed position for a majority of the operating time. In some cases, the brief exposure time of approximately 225 microseconds relative to the capture interval of approximately 10-22 milliseconds may result in the electromechanical lens cap 1210, 1310, 1400 being in the closed position for approximately 98-99% of the operating time, thereby reducing debris accumulation on the camera lens during agricultural spraying operations.

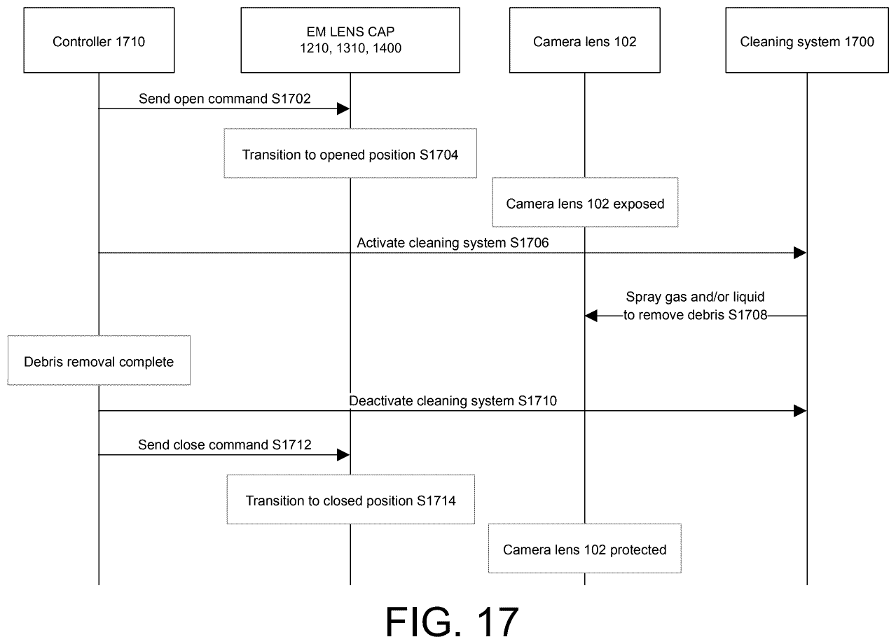

FIG. 17 is a sequence diagram representing a camera lens cleaning process according to one or more embodiments. The sequence diagram may include a controller 1710, the electromechanical lens cap 1210, 1310, 1400, a camera lens 102, and a cleaning system 1900. The sequence diagram may depict a process for cleaning the camera lens 102 while the electromechanical lens cap 1210, 1310, 1400 is in the opened position. The camera 100 can be the same as any of the cameras described herein.

With continued reference to FIG. 17, the process may begin with the controller 1710 sending an open command in step S1702 to the electromechanical lens cap 1210, 1310, 1400 to transition from the closed position to the opened position. In step S1704, the electromechanical lens cap 1210, 1310, 1400 may transition to the opened position, thereby exposing the camera lens 102. In some cases, the transition of the electromechanical lens cap 1210, 1310, 1400 to the opened position may allow access to the camera lens 102 for cleaning operations.

As further shown in FIG. 17, the controller 1710 may activate the cleaning system 1900 in step S1706 while the electromechanical lens cap 1210, 1310, 1400 remains in the opened position. In step S1708, the cleaning system 1900 may spray at least one of a gas and/or a liquid on the camera lens 102 to remove debris from the camera lens 102. In some cases, the cleaning system 1900 may spray the gas and/or the liquid across the camera lens 102 to dislodge and remove debris that may have accumulated during agricultural spraying operations. The debris removed from the camera lens 102 may include dust, dirt, and spray droplets that may have contacted the camera lens 102.

With continued reference to FIG. 17, once debris removal from the camera lens 102 is complete, the controller 1710 may deactivate the cleaning system 1900 in step S1710. In some cases, the deactivation of the cleaning system 1700 may occur after a predetermined cleaning duration or after a sensor indicates that the camera lens 102 is clean. The controller 1710 may then send a close command in step S1712 to the electromechanical lens cap 1210, 1310, 1400 to transition back to the closed position.

As further shown in FIG. 17, in the step S1714, the electromechanical lens cap 1210, 1310, 1400 may transition to the closed position, covering and protecting the camera lens 102 from debris such as dust, dirt, and spray droplets. In some cases, the coordinated operation between the controller 1710, the electromechanical lens cap 1210, 1310, 1400, the camera lens 102, and the cleaning system 1900 may provide active cleaning of the camera lens 102 while the electromechanical lens cap 1210, 1310, 1400 is in the opened position.

In some cases, the camera protection system may further comprise the Cleaning system 1900 configured to spray at least one of a gas and/or a liquid on the camera lens 102 to remove debris from the camera lens 102 while the electromechanical lens cap 1210, 1310, 1400 is in the opened position. The cleaning system 1900 may be configured to spray the gas, the liquid, or a combination of the gas and the liquid on and across the camera lens 102 during cleaning operations. In some cases, the gas may comprise compressed air or another compressed gas, and the liquid may comprise water or a cleaning solution. The coordinated operation depicted in FIG. 17 may allow the camera lens 102 to be actively cleaned while the electromechanical lens cap 1210, 1310, 1400 is in the opened position, with the electromechanical lens cap 1210, 1310, 1400 returning to the closed position after cleaning is complete to protect the camera lens 102 from further debris accumulation.

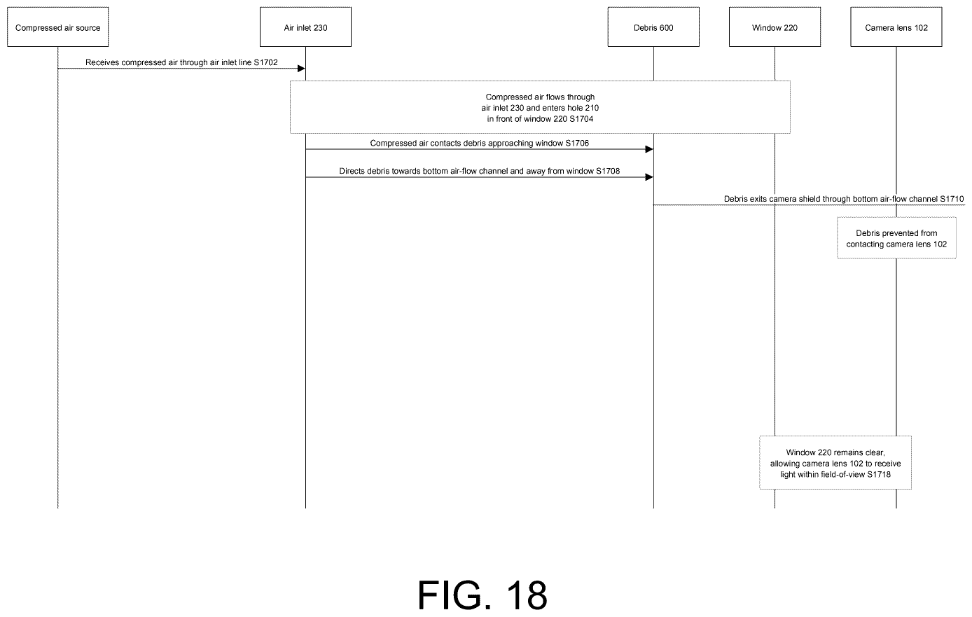

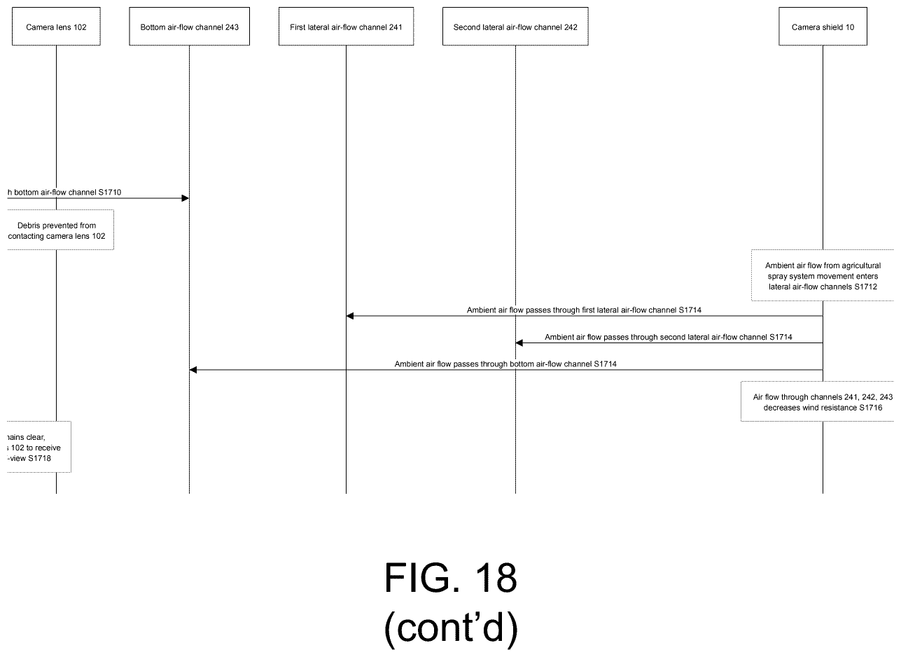

FIG. 18 is a sequence diagram representing an air-flow debris protection process for the camera shield 10 (FIG. 1) according to one or more embodiments. The sequence diagram may depict a process for protecting the camera lens 102 from particulates using compressed air flowing through the air inlet 230 and ambient air flow through the first lateral air-flow channel 241, the second lateral air-flow channel 242, and the bottom air-flow channel 243.

With continued reference to FIG. 18, the process may begin with the air inlet 230 receiving compressed air from a compressed air source through an air inlet line in step S1702. In some cases, the compressed air source may be external to the camera shield 10 and may supply compressed air or another compressed gas to the air inlet 230. In the step S1704, the compressed air may flow through the air inlet 230 and may enter the hole 210 in front of the window 220. In some cases, the compressed air may be distributed over a width of the hole 210 and the window 220 by the expanding outlet 232 of the air inlet 230.

As further shown in FIG. 18, in step S1706, the compressed air flowing through the air inlet 230 may contact the particulates 600 (FIGS. 6-10) approaching the window 220. The particulates 600 may include at least one of dust, dirt, and/or spray droplets that may be encountered during agricultural spraying operations. In the step S1708, the compressed air may direct the particulates 600 towards the bottom air-flow channel 243 and away from the window 220. In some cases, the downward flow of compressed air from the air inlet 230 may deflect the particulates 600 away from the window 220 and toward the bottom air-flow channel 243, preventing the particulates 600 from contacting the camera lens 102.

With continued reference to FIG. 18, in step S1710, the particulates 600 may exit the camera shield 10 through the bottom air-flow channel 243, preventing contact with the camera lens 102. In some cases, the particulates 600 may be carried out of the camera shield 10 by the compressed air flow and may exit through the bottom air-flow channel 243 at a bottom of the body 200. The direction of the particulates 600 through the bottom air-flow channel 243 may remove the particulates 600 from the vicinity of the window 220 and the camera lens 102.

As further shown in FIG. 18, concurrently with the compressed air flow through the air inlet 230, ambient air flow from agricultural spray system movement may enter the first lateral air-flow channel 241 and the second lateral air-flow channel 242 in step S1712. In some cases, the ambient air flow may be produced as the agricultural spray system, including the camera shield 10 and the camera 100, travels across an agricultural field. In the step S1714, the ambient air flow may pass through the first lateral air-flow channel 241, the second lateral air-flow channel 242, and the bottom air-flow channel 243.

With continued reference to FIG. 18, in step S1716, the air flow through the first lateral air-flow channel 241, the second lateral air-flow channel 242, and the bottom air-flow channel 243 may decrease wind resistance of the camera shield 10. In some cases, the passage of ambient air through the first lateral air-flow channel 241 and the second lateral air-flow channel 242 positioned on opposite sides of the body 200 may reduce aerodynamic drag on the camera shield 10 during operation of the agricultural spray system. The reduced wind resistance may allow the camera shield 10 to travel through the agricultural field with reduced aerodynamic forces acting on the camera shield 10.

As further shown in FIG. 18, in step S1718, the window 220 may remain clear, allowing the camera lens 102 to receive light within a field-of-view of the camera 100. In some cases, the combination of the compressed air flow through the air inlet 230 directing the particulates 600 away from the window 220 and the ambient air flow through the first lateral air-flow channel 241, the second lateral air-flow channel 242, and the bottom air-flow channel 243 may maintain optical clarity of the window 220 for image capture by the camera 100.

In some cases, the air-flow debris protection process depicted in FIG. 18 may provide dual functionality for the camera shield 10. The compressed air flowing through the air inlet 230 may actively deflect the particulates 600 away from the camera lens 102, while the first lateral air-flow channel 241, the second lateral air-flow channel 242, and the bottom air-flow channel 243 may reduce aerodynamic drag during operation of the agricultural spray system. In some cases, the coordinated operation of the compressed air flow and the ambient air flow through the air-flow channels may protect the camera lens 102 from debris accumulation while reducing wind resistance of the camera shield 10 as the agricultural spray system travels across the agricultural field.

In some cases, the various camera shield embodiments described herein may be combined in different configurations to provide enhanced protection for camera lenses on agricultural spray booms. The camera shield having the body, the hole, the window, the air inlet, and the air-flow channels may be used in combination with a mechanical shutter. In some cases, the mechanical shutter may be positioned behind the window of the camera shield, with the mechanical shutter configured to transition between the opened position and the closed position while the compressed air flowing through the air inlet directs debris towards the bottom air-flow channel and away from the window. The combination of the camera shield with the air-flow channels and the mechanical shutter may provide multiple layers of protection for the camera lens, with the compressed air deflecting debris away from the window and the mechanical shutter blocking debris from reaching the camera lens during periods when the camera is not capturing images.

In some cases, the camera shield having the body and the air-flow channels, the mechanical shutter, the camera shield with rotational states, the camera shield with the clear window, and the camera shield with the acoustic source may be combined in various configurations. The camera shield with rotational states may be combined with the camera shield having the body and the air-flow channels, with the camera shield with rotational states positioned behind the window to alternately expose and protect the camera lens while the compressed air flowing through the air inlet deflects debris away from the window. In some cases, the camera shield with the clear window that rotates about the central axis may be combined with the camera shield having the body and the air-flow channels, with the clear window positioned within or behind the window of the camera shield to provide centrifugal debris removal while the compressed air flow provides additional debris deflection.

In some cases, the camera shield with the acoustic source may be combined with the camera shield having the body and the air-flow channels, with the lens cover positioned within or behind the window and the acoustic source producing acoustic energy to vibrate the lens cover and remove accumulated debris while the compressed air flow deflects approaching debris away from the window. The mechanical shutter may be combined with the camera shield with the clear window, with the mechanical shutter positioned behind the clear window to provide protection during periods when the camera is not capturing images while the rotating clear window removes debris through centrifugal force during image capture periods.

In some cases, the mechanical shutter may be combined with the camera shield with the acoustic source, with the acoustic source producing acoustic energy to remove debris from the lens cover while the mechanical shutter provides protection during periods when the camera is not capturing images. The camera shield with rotational states may be combined with the camera shield with the acoustic source, with the acoustic source producing acoustic energy to remove debris from a surface of the camera shield with rotational states. In some cases, three or more of the camera shield embodiments may be combined to provide multiple mechanisms for debris protection and removal. The combination of multiple camera shield embodiments may provide redundant protection mechanisms that may reduce debris accumulation on the camera lens during agricultural spraying operations.

### EXAMPLE EMBODIMENTS

Example 1. A camera shield for an agricultural spray boom, comprising a body defining a hole extending from a front of the body to a back of the body, the hole including a window at the back of the body configured to be aligned with a camera lens; an air inlet defined in a top of the body, the air inlet configured to receive compressed air and extending into a top of the hole in front of the window; and a plurality of air-flow channels defined in the body, the plurality of air-flow channels including a first lateral air-flow channel, a second lateral air-flow channel, and a bottom air-flow channel, wherein compressed air flowing through the air inlet directs debris towards the bottom air-flow channel and away from the window.

Example 2. The camera shield of Example 1, wherein the air inlet includes an expanding outlet configured to distribute the compressed air over a width of the hole.

Example 3. The camera shield of Example 2, wherein the expanding outlet is configured to distribute the compressed air over a width of the window.

Example 4. The camera shield of any of Examples 1-3, further comprising a circular shield at the back of the body, wherein the window is defined in the circular shield.

Example 5. The camera shield of Example 4, wherein the circular shield is configured to cover a camera lens other than a portion of the camera lens corresponding to the window.

Example 6. The camera shield of any of Examples 1-5, wherein the first lateral air-flow channel and the second lateral air-flow channel are positioned on opposite sides of the body.

Example 7. The camera shield of Example 6, wherein air flow passing through the first lateral air-flow channel and the second lateral air-flow channel decreases wind resistance of the camera shield.

Example 8. The camera shield of any of Examples 1-7, wherein the air inlet is configured to be mechanically and fluidly coupled to an air inlet line to receive the compressed air.

Example 9. The camera shield of any of Examples 1-8, wherein the debris includes at least one of dust, dirt, or spray.

Example 10. The camera shield of any of Examples 1-9, wherein the camera shield is configured to be mounted on a camera that is mounted on a spray boom at an angle.

Example 11. The camera shield of any of Examples 1-10, wherein the window is configured to allow a camera lens to receive light within a field-of-view of a camera.

Example 12. A camera protection system for an agricultural spray boom, comprising: a camera having a camera lens; and a mechanical shutter configured to transition between an opened position in which the camera lens is exposed to capture an image and a closed position in which the mechanical shutter covers the camera lens to block debris from reaching the camera lens, wherein the mechanical shutter is configured to be in the closed position for a majority of an operating time of the camera.

Example 13. The camera protection system of Example 12, wherein the mechanical shutter is coupled to at least one of a motor, a linear actuator, or a rotary actuator configured to translate the mechanical shutter between the opened position and the closed position.

Example 14. The camera protection system of Example 12 or 13, wherein the camera is configured to capture images at a rate of 100 Hz or less with an exposure time of about 225 microseconds, and wherein the mechanical shutter is configured to be in the closed position for at least 98% of the operating time.

Example 15. The camera protection system of any of Examples 12-14, wherein the camera is configured to capture images at a rate of 45 to 50 Hz, and wherein the mechanical shutter is configured to be in the closed position for at least 99% of the operating time.

Example 16. The camera protection system of any of Examples 12-15, further comprising a cleaning system configured to spray at least one of a gas or a liquid on the camera lens to remove debris from the camera lens while the mechanical shutter is in the opened position.

Example 17. A camera shield, comprising: a clear window configured to be positioned in front of a camera lens; a housing to which the clear window is mounted; and a rotational mechanism configured to rotate the clear window about a central axis, wherein centrifugal force generated by rotation of the clear window causes debris contacting the clear window to move outward and off of the clear window.

Example 18. The camera shield of Example 17, wherein the rotational mechanism comprises at least one of a motor or a rotary actuator configured to rotate the clear window.

Example 19. The camera shield of Example 17 or 18, wherein the clear window comprises at least one of a clearview screen, a clear sight, a spin window, or a rotating windshield wiper.

Example 20. The camera shield of any of Examples 17-19, wherein the clear window is configured to provide the camera lens with a clear field of view while the clear window is rotating.

The invention should not be considered limited to the particular embodiments described above, but rather should be understood to cover all aspects of the invention as fairly set out in the attached claims. Various modifications, equivalent processes, as well as numerous structures to which the invention may be applicable, will be apparent to those skilled in the art to which the invention is directed upon review of this disclosure. The claims are intended to cover such modifications and equivalents.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

What is claimed is:

1. A camera shield comprising:
a body defining a hole extending between a first side of the body and an opposing second side of the body;
a lens shield defined on the second side of the body and configured to partially cover a front of a camera lens, the lens shield defining a window configured to be aligned with the camera lens and the hole, the hole and the window configured to allow light to reach the camera lens without obstructing a field-of-view of the lens;
a fluid port on the body, the fluid port fluidly coupled to a fluid inlet channel defined in the body, the fluid inlet channel fluidly coupling the fluid port and the hole, the fluid port configured to receive a fluid line; and
a fluid outlet channel defined in the body and fluidly coupling the hole to an external environment, the fluid outlet channel spatially aligned with the fluid inlet channel to form a compressed fluid path that extends from the fluid inlet channel to the fluid outlet channel and through the hole so as to deflect particulates from reaching the window and the camera lens.

2. The camera shield of claim 1, wherein:
the hole is defined between first and second sides of the body, and
a first axis extends through the first and second sides.

3. The camera shield of claim 2, wherein:
the fluid port is on a third side of the body,
the fluid inlet channel is defined in the third side of the body,
the fluid outlet channel is defined in a fourth side of the body, and
a second axis extends through the third and fourth sides, the second axis orthogonal to the first axis.

4. The camera shield of claim 3, wherein the second axis is parallel to a direction of gravitational pull.

5. The camera shield of claim 4, wherein the fourth side of the body is closer to the direction of gravitational pull than the third side.

6. The camera shield of claim 1, wherein the fluid line comprises a gas line.

7. The camera shield of claim 3, wherein:
the fluid inlet channel extends from the fluid port to an inner surface of the third side, the inner surface of the third side partially defining the hole, and
a width of the fluid inlet channel is greater at the inner surface of the third side than at the fluid port so as to distribute a fluid across a width of the hole, the width of the fluid inlet channel and the width of the hole measured with respect to a third axis that is orthogonal to the first and second axes.

8. The camera shield of claim 7, wherein
the fluid outlet channel extends from an inner surface of the fourth side to an outer surface of the fourth side, the inner surface of the fourth side partially defining the hole, and
a width of the fluid outlet channel at the inner surface of the fourth side is greater than the width of the fluid inlet channel at the inner surface of the third side, the width of the fluid outlet channel measured with respect to the third axis.

9. The camera shield of claim 8, wherein the width of the fluid outlet channel at the inner surface of the third side is approximately equal to a width of the window, the width of the window measured with respect to the third axis.

10. The camera shield of claim 3, further comprising:
a first air-flow channel defined in a fifth side of the body, the first air-flow channel fluidly coupling the hole to an external environment; and
a second air-flow channel defined in a sixth side of the body, the second air-flow channel fluidly coupling the hole to the external environment,
wherein:
the first and second air-flow channels are spatially aligned with each other to form an air-flow path that extends between the first air-flow channel and the second air-flow channel and through the hole, and
a third axis passes through the fifth and sixth sides, the third axis orthogonal to the first and second axes.

11. A camera shield system comprising:
the camera shield of claim 1;
a compressed fluid source; and
the fluid line, the fluid line fluidly coupling an outlet of the compressed fluid source to the inlet port of the camera shield.

12. The camera shield system of claim 11, wherein the compressed fluid source comprises a compressed gas source.

13. An assembly comprising:
the camera shield system of claim 11; and
a camera comprising the camera lens, the front of the camera lens disposed in the lens shield.

14. The assembly of claim 13, further comprising an agricultural spray boom having a frame, wherein the camera and the compressed fluid source are mounted on the frame of the spray boom.

15. A camera protection system, comprising:
a camera having a camera lens;
an electromechanical lens cap coupled to a front of the camera lens, the electromechanical lens cap configured to transition between an opened state in which at least a portion of the front of the camera lens is exposed to capture an image and a closed state in which the electromechanical lens cap covers the front of the camera lens to block particulates from reaching the front of the camera lens; and
a controller in communication with the electromechanical lens cap, the controller configured to set the electromechanical lens in the open state only for a time period sufficient for the camera to captures an image and to maintain the electromechanical lens in the closed state as a default state when the camera is idle.

16. The camera protection system of claim 15, wherein the electromechanical lens cap includes an actuator configured to physically move the electromechanical lens cap between the open state and the closed state.

17. The camera protection system of claim 15, wherein the electromechanical lens cap includes a plurality of retractable interleaving segments.

18. The camera protection system of claim 15, wherein:
the electromechanical lens cap includes a plurality of holes,
in the opened state one of the holes is spatially aligned with front of the camera, and
in the closed state the holes are not spatially aligned with the front of the camera.

19. An assembly comprising:
the camera protection system of claim 15; and
a spray boom having a frame, the camera mounted on the frame of the spray boom.

20. The assembly of claim 19, further comprising:
a compressed fluid source mounted on the spray boom; and
an electromechanical valve fluidly coupled to an outlet of the compressed fluid source and in communication with the controller, the electromechanical valve configured to transition from a closed position to an open position to spray a fluid onto the front of the lens when the electromechanical lens is in the open state so as to remove the particulates from the front of the lens.

21. A camera protection system, comprising:
a camera having a camera lens, the camera configured to capture images using one or more wavelengths of light;
a lens shield covering a front of the camera lens, the lens shield comprising an optically transparent material with respect to the one or more wavelengths of light; and
a motor coupled to the lens shield to rotate the lens shield about a central axis that passes through the lens shield and the camera lens so as to remove debris from the lens shield.

22. An assembly comprising:
the camera protection system of claim 21; and
a spray boom having a frame, the camera mounted on the frame of the spray boom.
